(19) United States
(12) Patent Application Publication
(10) Pub. No.: US 2011/0129731 A1
(43) Pub. Date: Jun. 2, 2011

(54) ELECTRODE FOR LITHIUM-ION SECONDARY BATTERY

(76) Inventors: Yasuhiro Wakizaka, Kanagawa-ken (JP); Mayumi Fukumine, Kanagawa-ken (JP)

(21) Appl. No.: 13/057,651

(22) PCT Filed: Aug. 4, 2009
(86) PCT No.: PCT/JP2009/063783

§ 371 Date: Feb. 4, 2011

(30) Foreign Application Priority Data
Aug. 5, 2008 (JP) 2008-202243

(51) Int. Cl. H01M 4/62; H01M 4/02; B05D 5/12; B05D 3/00

(52) U.S. Cl. 429/217; 429/218.1; 427/58

(57) ABSTRACT

Disclosed is an electrode for a lithium-ion secondary battery in which a porous membrane containing an oxide particle having a particle size of 5 nm or more to 100 nm or less is layered on an electrode active material layer; a slurry for a porous membrane comprising an oxide particle having a particle size of 5 nm or more to 100 nm or less, a polymer having a glass-transition temperature of 15° C. or less and a solvent; and a lithium-ion secondary battery comprising a positive electrode, a negative electrode and an electrolyte solution in which at least one of the positive electrode and negative electrode is the electrode of the present invention. The purpose is to provide a porous membrane able to contribute to reduction of an attached matter to a roll when being wound up due to improved retention of inorganic filler on the surface part of the porous membrane for a porous protective membrane provided on the surface of an electrode used for a secondary battery and the like.

### TECHNICAL FIELD

The present invention relates to an electrode for a lithium-ion secondary battery having a porous membrane, further specifically an electrode for a lithium-ion secondary battery having a porous membrane able to contribute to membrane smoothness, strength and the like. Also, the present invention relates to a lithium-ion secondary battery equipped with the electrode having a porous membrane.

### BACKGROUND ART

A lithium-ion secondary battery shows the highest energy density among practically-used batteries, and particularly, is commonly used for small size electronics. Also, it is expected to be developed for automobile as well as small size usage. Under the circumstances, it is demanded to get longer operating life and to further improve safety in the lithium-ion secondary battery.

The lithium-ion secondary battery is in general equipped with a positive electrode and negative electrode, including an electrode active material layer supported by a collector, as well as a separator and nonaqueous electrolyte solution. The electrode active material layer includes an electrode active material, having an average particle size of 5 to 50 μm or so, and a binder. The electrode can be fabricated by coating material mixture slurry containing powdery electrode active material on the collector to form an electrode active material layer. Also, as the separator to isolate the positive electrode and negative electrode, very thin separator having a thickness of 10 to 50 μm or so is used. The lithium-ion secondary battery can be produced via steps such as a layering step of the electrode and separator and a cutting step for cutting the layered electrode in a predetermined electrode shape. However, during the series of production steps, active materials may be dropped off the electrode active material layer, and a part of the dropped active materials may be included in a battery as a contaminant, in some cases.

Such a contaminant can be 5 to 50 μm or so in particle size, and comparable with the separator in thickness, so that the contaminants can penetrate through the separator within the assembled battery to cause short circuit. Also, at the operation of the battery, heat can be generated. As a result, the separator made from stretched polyethylene resin and the like can also be heated. The separator made from the stretched resin is in general contracted even at a temperature of 150° C. or less to easily cause short circuit of the battery. Also, when sharp-shaped, nail-like projection penetrates through the battery (e.g. at nail penetration test), the battery may instantly short-circuit to generate heat of reaction, so that the short-circuit portion may be expanded.

Therefore, to solve the above problems, it is proposed that inorganic filler is included on or within the separator. By including the inorganic filler, the strength of the separator can be increased to improve safety.

Also, by coating a porous membrane comprised of the inorganic filler on the electrode instead of coating the inorganic filler on the separator, a porous membrane layer is free from contract due to heat, so that risk of short circuit can be greatly decreased and it is expected to significantly improve safety. Furthermore, by providing the porous membrane, it is possible to prevent the active material from dropping during the process of producing the battery. In addition, due to porous membrane structure, the electrolyte solution can be prevented from permeating the protective membrane to disturb battery reaction.

For example, Patent Document 1 discloses a porous protective membrane formed on the electrode by using a particulate slurry containing particulates such as alumina, silica and polyethylene resin. Also, in Patent Document 2, it is studied that movement of lithium is controlled by pore size control by changing the particle size of inorganic filler having a variety of particle sizes, where an average particle size is in the range of 0.2 to 1.5 μm, between the side of the porous membrane layer surface and the side of the electrode.

However, when using the inorganic filler having the above particle size, it is necessary to have a roll cleaning process because the porous membrane may be adhered to a wind-up roll during a wind-up process of a porous membrane coated electrode, etc. Also, the target performance as the protective membrane tends to be deteriorated due to peeling of the porous membrane at the wind-up process.
[Patent Document 1] The Japanese Unexamined Patent Publication H7-220759
[Patent Document 1] The Japanese Unexamined Patent Publication 2005-294139

### DISCLOSURE OF INVENTION

### Problem to be Solved by the Invention

The present invention was made in view of the above conventional technology, and the purpose is to provide an electrode for a lithium-ion secondary battery having a porous membrane able to contribute to improvements in membrane smoothness and strength in an electrode used for a lithium-ion secondary battery.

### Means for Solving the Problem

As a result of keen investigation to solve the above problems, the present inventors found that joining strength between a porous membrane and an electrode is increased by an oxide particle having a particle size of in a specific range included in the porous membrane, which allows reduction in dropping powder at wind-up and makes it easier to control slurry viscosity at the time of coating of slurry for a porous membrane, resulting in obtaining a porous membrane showing high smoothness; and came to complete the present invention.

The present invention solving the above problems includes the following features as its gist.

(1) An electrode for a lithium-ion secondary battery, wherein a porous membrane containing an oxide particle having a particle size of 5 nm or more to 100 nm or less is layered on an electrode active material layer.

(2) The electrode for a lithium-ion secondary battery as set forth in the above (1), wherein said porous membrane further includes a binder.

(3) The electrode for a lithium-ion secondary battery as set forth in the above (2), wherein said binder includes a polymer having a glass-transition temperature of 15° C. or less.

(4) A slurry for a porous membrane comprising an oxide particle having a particle size of 5 nm or more to 100 nm or less, a polymer having a glass-transition temperature of 15° C. or less and a solvent.

(5) A method for producing an electrode for a lithium-ion secondary battery comprising: coating the slurry for a porous membrane as set forth in the above (4) on an electrode active material layer; and then drying the same.

(6) A lithium-ion secondary battery comprising a positive electrode, a negative electrode and an electrolyte solution, wherein at least one of the positive electrode and negative electrode is the electrode as set forth in the above (1).

### Effects of the Invention

According to the present invention, there is provided a porous membrane able to contribute to inhibition of dropping powder at wind-up of a roll. The porous membrane is formed on the surface of an electrode for a secondary battery, functions as a protective membrane for the electrode, and has increased retention of inorganic filler in the surface part of the porous membrane to contribute to preventing adhesion to the roll at wind-up of a roll.

### MODES FOR WORKING THE INVENTION

Hereinafter, the present invention will be explained in detail.

In the electrode for a lithium-ion secondary battery of the present invention, a porous membrane containing an oxide particle having a particle size of 5 nm or more to 100 nm or less is layered on an electrode active material layer

(Oxide Particle Having a Particle Size of 5 nm or More to 100 nm or Less)

In the present invention, the porous membrane contains the oxide particle having a particle size of 5 nm or more to 100 nm or less.

The above particle size of the oxide particle is preferably 7 nm or more to 50 nm or less, further preferably 10 nm or more to 40 nm or less. By using the oxide particle having the particle size of in the above range, it is easier to obtain viscosity in the after-mentioned slurry for a porous membrane to improve the membrane smoothness.

As an oxide constituting the oxide particle having the particle size of 5 nm or more to 100 nm or less, there may be mentioned alumina (Al₂O₃), titanium oxide (TiO₂), silicon oxide (SiO₂), magnesium oxide (MgO), zirconium oxide, etc. These may be used alone or in combination of 2 or more. As a particle having a primary particle size of 5 nm or more to 100 nm or less, for example, Aerosile (product name) of Degussa, CAB-O-SIL (product name) of Cabot, Aluminiumoxid C of Degussa, or other oxides such as fumed silica and fumed alumina, titania, silica, alumina and zirconium oxide may be used.

In the present invention, the porous membrane is layered on the surface of the electrode (electrode active material layer), and by the oxide particle having a particle size of 5 nm or more to 100 nm or less included in the porous membrane, a part of the above particles can penetrate surface pore portion in the electrode at the time of coating, resulting in dramatically improving joining strength between the electrode active material layer and porous membrane.

Also, because the above particles are present in the porous membrane, the strength of the porous membrane itself can be improved, and as a result, dropping powder caused by partial peel-off of the porous membrane at wind-up of a roll can be significantly improved.

Furthermore, when the after-mentioned slurry for a porous membrane is coated on the surface of the electrode active material layer and dried to form the porous membrane, viscosity of the slurry for a porous membrane can easily be controlled by the above oxide particle included therein. Particularly, migration due to convective flow of the slurry for a porous membrane during drying can be inhibited by providing structural viscosity (thixotropy) to the slurry for a porous membrane, so that it is possible to obtain the porous membrane having uniform thickness.

For this reason, the ratio of the above oxide particle in the porous membrane can be, as content in the volumetric basis, preferably 1 to 50 vol %, further preferably 2 to 30 vol %, most preferably 5 to 15 vol %, and as content in the weight basis, preferably 2 to 50 mass %, further preferably 2 to 30 mass %, most preferably 5 to 15 mass %. By making the above oxide particle included in the above range, the slurry for a porous membrane can be provided with structural viscosity to improve coating property, and as further effect, the strength of the porous membrane can be increased.

Content and particle size of the oxide particle having a particle size of 5 nm or more to 100 nm or less in the porous membrane can be measured by elemental mapping of cross-sectional surface of the electrode with EPMA and image analysis of the same with FE-SEM or FE-TEM.

(Binder)

In the present invention, it is preferable to include binder in the porous membrane in addition to the above oxide particle. By inclusion of the binder, mechanical strength of the porous membrane can be maintained.

For the binder, a variety of resin components and soft polymer can be used.

For example, as the resin component, polyethylene, polytetrafluoroethylene (PTFE), polyvinylidene fluoride (PVDF), tetrafluoroethylene-hexafluoropropylene copolymer (FEP), polyacrylic acid derivative, polyacrylonitrile derivative, etc., can be used. These can be used alone or in combination of two or more.

As the soft polymer, there may be mentioned acrylic soft polymer, which is homopolymer of acrylic acid or methacrylic acid derivative or copolymer of the same with its copolymerizable monomer, such as polybutyl acrylate, polybutyl methacrylate, polyhydroxyethyl methacrylate, polyacrylamide, polyacrylic nitrile, butyl acrylate-styrene copolymer, butyl acrylate-acrylic nitrile copolymer and butyl acrylate-acrylic nitrile-glycidyl methacrylate copolymer;

isobutylene-based soft polymer such as polyisobutylene, isobutylene-isoprene rubber and isobutylene-styrene copolymer;

diene-based soft polymer such as polybutadiene, polyisoprene, butadiene-styrene random copolymer, isoprene-styrene random copolymer, acrylic nitrile-butadiene copolymer, acrylic nitrile-butadiene-styrene copolymer, butadiene-styrene-block copolymer, styrene-butadiene-styrene-block copolymer, isoprene-styrene-block copolymer and styrene-isoprene-styrene-block copolymer;

silicon containing soft polymer such as dimethyl polysiloxane, diphenyl polysiloxane and dihydroxy polysiloxane;

olefinic soft polymer such as liquid polyethylene, polypropylene, poly-1-butene, ethylene-α-olefin copolymer, propylene-α-olefin copolymer, ethylene-propylene-diene copolymer (EPDM) and ethylene-propylene-styrene copolymer;

vinyl-based soft polymer such as polyvinyl alcohol, polyvinyl acetate, poly vinyl stearate and vinyl acetate-styrene copolymer;

epoxy-based soft polymer such as polyethylene oxide, polypropylene oxide and epichlorohydrin rubber;

fluorine containing soft polymer such as vinylidene fluoride-based rubber and ethylene tetrafluoride-propylene rubber;

other soft polymer including natural rubber, polypeptide, protein, polyester-based thermoplastic elastomer, vinyl chloride-based thermoplastic elastomer and polyamide-based thermoplastic elastomer.

The soft polymer may be those having a cross-linked structure, and also, those in which a functional group is introduced by denaturalization.

Among these, particularly, the polymer having glass-transition temperature of 15° C. or less is preferable. By making the glass-transition temperature of the binder 15° C. or less, the porous membrane can be provided with flexibility at room temperature, and it is possible to inhibit crack, missing of the electrode and the like at wind-up of a roll or at roll-up of the electrode. Note that the glass-transition temperature of the polymer can be adjusted by combining various monomers.

From these viewpoints, acrylic soft polymer, isobutylene-based soft polymer and diene-based soft polymer are preferable among the above soft polymers. Particularly, acrylic soft polymer is preferable because this polymer is stable in oxidation-reduction and it is easy to obtain a battery with longer lifetime.

Furthermore, when the surface of the oxide particle having a particle size of 5 nm or more to 100 nm or less is hydrophilic, the polymer having a hydrophilic functional group is preferable for attaining high dispersing stability and binding strength of the particle.

As the hydrophilic functional group, a carboxylic group, hydroxyl group and sulfonic group may be mentioned. The hydrophilic functional group at the production of the polymer can be introduced by copolymerizing with a monomer containing a hydrophilic functional group or polymerizing by using a polymerization initiator containing the above hydrophilic functional group.

As the monomer containing a carboxylic group, there may be mentioned monocarboxylic acid and derivatives thereof, dicarboxylic acid, acid anhydride and derivatives thereof.

The monocarboxylic acid may include acrylic acid, methacrylic acid, crotonic acid, etc.

The monocarboxylic acid derivative may include 2-ethylacrylic acid, isocrotonic acid, α-acetoxy acrylic acid, β-trans-aryloxy acrylic acid, α-chloro-β-E-methoxy acrylic acid, β-diamino acrylic acid, etc.

The dicarboxylic acid may include maleic acid, fumaric acid, itaconic acid, etc.

The acid anhydride of dicarboxylic acid may include maleic acid anhydride, acrylic acid anhydride, methylmaleic acid anhydride, dimethyl maleic acid anhydride, etc.

The dicarboxylic acid derivative may include maleic acid methyl allyl such as methylmaleic acid, dimethyl maleic acid, phenyl maleic acid, chloromaleic acid, dichloromaleic acid and fluoromaleic acid; maleic acid ester such as diphenyl maleate, nonyl maleate, decyl maleate, dodecyl maleate, octadecyl maleate and fluoroalkyl maleate; etc.

As the monomer containing a hydroxyl group, there may be mentioned ethylenic unsaturated alcohol such as (meth)allyl alcohol, 3-butene-1-ol and 5-hexene-1-ol; alkanol esters of ethylenic unsaturated carboxylic acid such as acrylic acid-2-hydroxyethyl, acrylic acid-2-hydroxypropyl, methacrylic acid-2-hydroxyethyl, methacrylic acid-2-hydroxypropyl, maleic acid-di-2-hydroxyethyl, maleic acid di-4-hydroxy butyl and itaconic acid di-2-hydroxypropyl; esters of polyalkylene glycol and (meth)acrylic acid expressed by a general formula of CH₂═CR¹—COO—(CₙH₂ₙO)ₘ—H (where “m” is an integer of 2 to 9, “n” is an integer of 2 to 4, and R¹ is a hydrogen or methyl group);

mono(meth)acrylic acid esters of dihydroxy ester of dicarboxylic acid such as 2-hydroxyethyl-2′-(meth)acryloyl oxyphthalate and 2-hydroxyethyl-2′-(meth)acryloyl oxysuccinate; vinyl ethers such as 2-hydroxyethyl vinyl ether and 2-hydroxypropyl vinyl ether; mono(meth)allyl ethers of alkylene glycol such as (meth)allyl-2-hydroxyethyl ether, (meth)allyl-2-hydroxypropyl ether, (meth)allyl-3-hydroxypropyl ether, (meth)allyl-2-hydroxy butyl ether, (meth)allyl-3-hydroxy butyl ether, (meth)allyl-4-hydroxy butyl ether and (meth)allyl-6-hydroxy hexyl ether; polyoxyalkylene glycol mono(meth)allyl ethers such as diethylene glycol mono(meth)allyl ether and dipropylene glycol mono(meth)allyl ether; mono(meth)allyl ether of halogen- and hydroxy substituted (poly)alkylene glycol such as glycerin mono(meth)allyl ether, (meth)allyl-2-chloro-3-hydroxypropyl ether and (meth)allyl-2-hydroxy-3-chloropropyl ether; mono(meth)allyl ether of polyhydric phenol and halogen-substitute thereof such as eugenol and isoeugenol; (meth)allyl thioethers of alkylene glycol such as (meth)allyl-2-hydroxyethyl thioether and (meth)allyl-2-hydroxypropyl thioether; etc.

As the monomer containing a sulfonic group, there may be mentioned vinyl sulfonic acid, methyl vinyl sulfonic acid, (meth)allyl sulfonic acid, styrene sulfonic acid, (meth)acrylic acid-2-sulfonic acid ethyl, 2-acrylamide-2-methylpropane sulfonic acid, 3-allyloxy-2-hydroxy propane sulfonic acid, etc.

The content of the hydrophilic functional group in the polymer is preferably in the range of 0.3 to 40 mass %, further preferably in the range of 3 to 20 mass %, per 100 mass % of the whole monomers as the amount of monomers containing a hydrophilic functional group at polymerization. The content of the hydrophilic functional group in the polymer can be controlled by the ratio of monomers loaded for producing the polymer. When the content of the hydrophilic functional group in the polymer is within the range, the adsorbed amount of the polymer to oxide particle having a particle size of 5 nm or more to 100 nm or less and inorganic filler added as needed can be balanced with free polymer amount in the after-mentioned slurry for a porous membrane, resulting in excellent dispersibility of the oxide particle having a particle size of 5 nm or more to 100 nm or less and the inorganic filler added as needed, and excellent binding property between oxide particle having a particle size of 5 nm or more to 100 nm or less and the inorganic filler added as needed.

The content of the binder in the porous membrane is preferably 0.1 to 10 mass %, further preferably 0.5 to 5 mass %. Since the content of the binder in the porous membrane is within the above range, binding property between the above oxide particles and other inorganic fillers, and binding with electrode, as well as flexibility, can be maintained, so that it is possible not to disturb Li movement and to inhibit increase in resistance.

(Inorganic Filler)

In the present invention, as the inorganic filler, inorganic filler having a particle size of over 100 nm may be used as well as the above oxide particle having a particle size of 5 nm or more to 100 nm or less.

The particle size of the inorganic filler is preferably more than 100 nm to 5 μm or less, more preferably 200 nm or more to 2 μm or less. When the particle size is increased, the thickness of the porous membrane may be increased for forming uniform porous membrane and the capacity in a battery may be decreased.

BET specific surface area of the inorganic filler is, for example, preferably 0.9 m²/g or more, further preferably 1.5 m²/g or more. Particularly, in view of inhibiting agglomeration of the inorganic filler and optimizing fluidity of the after-mentioned slurry for a porous membrane, it is preferable that the BET specific surface area is not too large and for example, 150 m²/g or less.

As the inorganic filler, oxide particle such as aluminum oxide, silicon oxide, magnesium oxide, titanium oxide, BaTiO₃, ZrO and alumina-silica complex oxide; nitride particle such as aluminum nitride and boron nitride; covalent crystal particle such as silicon and diamond; poorly-soluble ion crystal particle such as barium sulfate, calcium fluoride and barium fluoride; clay particulate such as talc and montmorillonite; and etc. can be used. These particles may be subject to element substitution, surface treatment, solid solution formation and the like as needed, and may be used alone and in combination of 2 or more. Among these, oxide particle is preferable in view of stability in the electrolyte solution and potential stability.

The content of the inorganic filler in the porous membrane is preferably 2 to 50 times more (based on mass), further preferably 5 to 20 times more (based on mass), than the content of the above oxide particle having a particle size of 5 nm or more to 100 nm or less. Since the inorganic filler is included in the porous membrane within the above range, pore size in the porous membrane can be increased and it is possible to obtain the porous membrane with high retention of the electrolyte solution and high rate characteristic.

The porous membrane may further include other components such as dispersant and additive for electrolyte solution having a function to inhibit degradation of the electrolyte solution in addition to the above component. These are not particularly limited unless these affect the battery reaction.

As the dispersant, there may be illustrated anionic compound, cationic compound, nonionic compound and polymer compound. The dispersant can be selected depending on the used filler.

In addition to the above, there may be mentioned surfactants such as alkyl-based surfactant, silicon-based surfactant, fluorine-based surfactant and metallic surfactant. By mixing the above surfactant, it is possible to prevent repelling at coating and to improve smoothness of the electrode. The content of the surfactant in the porous membrane is preferably in the range not to affect the battery characteristic and preferably 10 mass % or less.

(Electrode Active Material)

The electrode active material layer used in the present invention includes the electrode active material as its essential component.

The electrode active material used in an electrode for a lithium-ion secondary battery may be any one able to reversibly insert and release lithium-ion by producing a potential in the electrolyte, and either inorganic compound or organic compound can be used.

The electrode active material for a positive electrode (positive electrode active material) for a lithium-ion secondary battery can be roughly divided into a group of inorganic compound and a group of organic compound. The positive electrode active material in the group of inorganic compound may include transition metal oxide, complex oxide of lithium and transition metal, transition metal sulfide, etc. As the above transition metal, Fe, Co, Ni, Mn and the like can be used. Specific examples of the inorganic compound used for the positive electrode active material may include lithium containing combined metal oxide such as LiCoO₂, LiNiO₂, LiMnO₂, LiMn₂O₄, LiFePO₄ and LiFeVO₄; transition metal sulfide such as TiS₂, TiS₃ and amorphous MoS₂; transition metal oxide such as Cu₂V₂O₃, amorphous V₂O—P₂O₅, MoO₃, V₂O₅ and V₆O₁₃. These compounds may partially be element substituted. For the positive electrode active material in the group of organic compound, for example, a conductive polymer such as polyacetylene and poly-p-phenylene can be used. An iron-based oxide, poor in electric conductivity, may be subject to reduction firing in the presence of the source of carbon and can be used as an electrode active material coated with carbon material. Also, these compounds may partially be element substituted.

The positive electrode active material for a lithium-ion secondary battery may be a mixture of the above inorganic compound and organic compound. The particle size of the positive electrode active material may be properly selected depending on the other battery requirements, and 50%-volume cumulative diameter is normally 0.1 to 50 μM, preferably 1 to 20 μm, in view of improvement in battery characteristics such as load characteristic and cycle characteristic. When the 50%-volume cumulative diameter is within the range, a secondary battery having large charge-discharge capacity can be obtained, and also it is easy for handling at production of slurry for electrode and an electrode. 50%-volume cumulative diameter can be obtained by measuring particle size distribution by laser diffraction.

As the electrode active material for a negative electrode (negative electrode active material) for a lithium-ion secondary battery, for example, there may be mentioned carbonaceous material such as amorphous carbon, graphite, natural black lead, mesocarbon microbead and pitch-based carbon fiber, conductive polymer such as polyacene, etc. Also, as the negative electrode active material, a metal such as silicon, tin, zinc, manganese, iron and nickel, the alloy thereof, oxide and sulfate of the above metal or alloy can be used. In addition, metal lithium, lithium alloy such as Li—Al, Li—Bi—Cd and Li—Sn—Cd, nitride of lithium-transition metal, silicon, etc., can be used as well. The electrode active material in which a conductivity providing agent is adhered to its surface by mechanical reforming process can also be used. The particle size of the negative electrode active material can properly selected depending on the other battery requirements, and 50%-volume cumulative diameter is normally 1 to 50 μm, preferably 15 to 30 μm, in view of improvement in battery characteristics such as initial efficiency, load characteristic and cycle characteristic.

In the present invention, it is preferable that the electrode active material layer includes a binder in addition to the electrode active material. By the binder included therein, risks such as short circuit due to the detached may be reduced because binding property of the active material layer can be improved in the electrode, strength to mechanical force during winding step of the electrode and the like can be increased, and the active material layer in the electrode is hardly detached.

Various resin components can be used for the binder. For example, polyethylene, polytetrafluoroethylene (PTFE), polyvinylidene fluoride (PVDF), tetrafluoroethylene-hexafluoropropylene copolymer (FEP), polyacrylic acid derivative, polyacrylonitrile derivative and the like can be used. These may be used alone or in combination of two or more.

Furthermore, the soft polymer exemplified as below can be used as the binder:

acrylic soft polymer which is a homopolymer of acrylic acid or methacrylic acid derivative or a copolymer thereof with its copolymerizable monomer, such as poly butyl acrylate, poly butyl methacrylate, poly hydroxymethyl methacrylate, polyacrylamide, polyacrylic nitrile, butyl acrylate-styrene copolymer, butyl acrylate-acrylic nitrile copolymer and butyl acrylate-acrylic nitrile-glycidyl methacrylate copolymer;

isobutylene-based soft polymer such as isobutylene, isobutylene-isoprene rubber and isobutylene-styrene copolymer;

diene-based soft polymer such as polybutadiene, polyisoprene, butadiene-styrene random copolymer, isoprene-styrene random copolymer, acrylic nitrile-butadiene copolymer, acrylic nitrile-butadiene-styrene copolymer, butadiene-styrene-block copolymer, styrene-butadiene-styrene-block copolymer, isoprene-styrene-block copolymer and styrene-isoprene-styrene-block copolymer;

silicon containing soft polymer such as dimethyl polysiloxane, diphenyl polysiloxane and dihydroxy polysiloxane;

olefinic soft polymer such as liquid polyethylene, polypropylene, poly-1-butene, ethylene-α-olefin copolymer, propylene-α-olefin copolymer, ethylene-propylene-diene copolymer (EPDM) and ethylene-propylene-styrene copolymer;

vinyl-based soft polymer such as polyvinyl alcohol, polyvinyl acetate, polyvinyl stearate and vinyl acetate-styrene copolymer;

epoxy-based soft polymer such as polyethylene oxide, polypropylene oxide and epichlorohydrin rubber;

fluorine containing soft polymer such as vinylidene fluoride-based rubber and ethylene tetrafluoride-propylene rubber; and

other soft polymer such as natural rubber, polypeptide, protein, polyester thermoplastic elastomer, vinyl chloride-based thermoplastic elastomer and polyamide thermoplastic elastomer, etc. may be mentioned. These soft polymers may include the one having a cross-linked structure, and the one having a functional group introduced by denaturalization.

The amount of the binder in the electrode active material layer is preferably 0.1 to 5 parts by mass, more preferably 0.2 to 4 parts by mass and particularly preferably 0.5 to 3 parts by mass, per 100 parts by mass of the electrode active material. With the amount of the binder of in the range, it is possible to prevent the active material from dropping off the electrode without disturbing the battery reaction.

The binder is prepared in the form of solution or dispersant fluid for producing an electrode. The viscosity at the preparation is normally in the range of 1 mPa·S to 300,000 mPa·S, preferably 50 mPa·S to 10,000 mPa·S. The viscosity is measured at 25° C. with a revolution of 60 rpm by using B-type viscometer.

In the present invention, the electrode active material layer may contain a conductivity providing agent. As the conductivity providing agent, conductive carbon such as acetylene black, Ketjen black, carbon black, graphite, vapor-grown carbon fiber and carbon nanotube can be used. There may be mentioned carbon power such as black lead, fiber or foil of a variety of metals, etc. As a reinforcing material, a variety of inorganic and organic fillers having spherical shape, sheet shape, rod shape or fibrous form can be used. By using the conductivity providing agent, it is possible to improve electric interengagement between the electrode active materials, and to improve discharge rate characteristic when used in a lithium-ion secondary battery. The used amount of the conductivity providing agent is normally 0 to 20 parts by mass, preferably 1 to 10 parts by mass, per 100 parts by mass of the electrode active material.

The electrode active material layer may exist alone or in the state of adhering to a collector.

The electrode active material layer can be formed by adhering slurry containing the electrode active material and solvent (hereinafter may be referred to as “material mixture slurry”) to the collector.

The solvent may be any one able to either dissolve the binder or disperse the same to particles when the electrode active material layer contains the binder, and the solvent able to dissolve is preferable. When using the solvent which dissolves the binder, the binder is adsorbed to the surface to stabilize the dispersion of the electrode active material and the like.

The material mixture slurry contains the solvent, in which the electrode active material, binder and conductivity providing agent are dispersed. It is preferable to use the solvent able to dissolve the binder because dispersibility of the electrode active material and conductivity providing agent is excellent. It can be estimated that the dispersion is stabilized by volume effect due to the fact that the binder is adsorbed to the surface of the electrode active material and the like when the binder able to be dissolved in the solvent is used.

For the solvent used in the material mixture slurry, either water or organic solvent can be used. The organic solvent may include cyclic aliphatic hydrocarbons such as cyclopentane and cyclohexane; aromatic hydrocarbons such as toluene and xylene; ketones such as ethyl methyl ketone and cyclohexanone; esters such as ethyl acetate, butyl acetate, γ-butyrolactone and ε-caprolactone; acylonitriles such as acetonitrile and propionitrile; ethers such as tetrahydrofuran and ethylene glycol diethyl ether; alcohols such as methanol, ethanol, isopropanol, ethylene glycol and ethylene glycol monomethyl ether; amides such as N-methylpyrrolidone and N,N-dimethyl formamide; etc. These solvents can be used alone or in mixture of 2 or more, and properly selected depending on drying rate and environments. Among these, it is preferable to use nonaqueous solvent in the present invention in view of electrode expansion characteristic to water.

The material mixture slurry may further contain additives having a variety of functions such as thickener, conducting material and reinforcing material. As the thickener, polymer soluble in the organic solvent used in the material mixture slurry can be used. Specifically, hydrogenated acrylic nitrile-butadiene copolymer and the like can be used.

Furthermore, trifluoropropylene carbonate, vinylene carbonate, catechol carbonate, 1,6-dioxaspiro[4,4]nonane-2,7-dione, 12-crown-4-ether and the like can be used for the material mixture slurry to increase stability or life of battery. Also, these may be included in the after-mentioned electrolyte solution.

The amount of the organic solvent in the material mixture slurry may be adjusted to use depending on the types of the electrode active material, binder and the like, so as to have viscosity preferable for coating. Specifically, the amount can be adjusted to use such that the concentration of combined solid contents of the electrode active material, binder and other additives is preferably 30 to 90 mass %, more preferably 40 to 80 mass %.

The material mixture slurry can be obtained by mixing the electrode active material, optionally-added binder, conductivity providing agent, other additives and organic solvent by using a blending machine. Mixing may be done by collectively providing each of the above components into the blending machine. When the electrode active material, binder, conductivity providing agent and thickener are used as structural components for the material mixture slurry, it is preferable that the conductivity providing agent and thickener are mixed in the organic solvent to disperse the conducting material to particles, followed by adding the binder and electrode active material for further mixing because the dispersibility of the slurry can be improved. For the blending machine, ball mill, sand mill, pigment dispersing machine, stone mill, ultrasonic dispersing machine, homogenizer, planetary mixer, Hobart mixer and the like can be used, and it is preferable to use the ball mill because agglomeration of the conductivity providing agent and electrode active material can be inhibited.

The particle size of the material mixture slurry is preferably 35 μm or less, further preferably 25 μm or less. When the particle size of the slurry is within the above range, dispersibility of the conducting material is high, and homogeneous electrode can be obtained.

(Collector)

The collector is not particularly limited if this is a material having electric conductivity and electrochemical durability, and for example, metal materials such as iron, copper, aluminum, nickel, stainless steel, titanium, tantalum, gold and platinum are preferable in view of their heat resistance. Among these, aluminum is particularly preferable for the positive electrode of a nonaqueous electrolyte secondary battery, and copper is particularly preferable for the negative electrode. The shape of the collector is not particularly limited, and the sheet-shaped collector having a thickness of about 0.001 to 0.5 mm is preferable. It is preferable that the collector is preliminarily subject to roughening treatment before the use for increasing adhering strength of the material mixture. Method of the roughening treatment may include mechanical method of polishing, electropolishing, chemical polishing, etc. In the mechanical method of polishing, coated abrasive in which abrasive particles are fixed, grinding stone, emery buff, wire-brush provided with steel wire and the like, etc. can be used. Also, an intermediate layer may be formed on the surface of the collector to increase the adhering strength and conductivity of the electrode material mixture layer.

(Method of Production of Electrode Active Material Layer)

The method of production of an electrode active material layer may be the method in which the electrode active material layers are bound to at least one side, preferably both sides, of the collector, in the form of layers. For example, the material mixture slurry is coated on the collector, dried, and then, thermally treated at 120° C. or more for 1 hour or more to form the electrode active material layer. The method for coating the material mixture slurry onto the collector is not particularly limited. There may be mentioned, for example, doctor blade method, dip method, reverse roll method, direct roll method, gravure method, extrusion method, brush method, etc. For the drying method, for example, there may be mentioned drying by warm air, hot air or low wet air, vacuum drying, drying method with irradiation of (far-)infrared rays, electron beam and the like.

Then, it is preferable to lower porosity of the electrode active material layer of the electrode by pressure treatment with mold press, roll press and the like. The preferable range of the porosity is 5% to 15%, more preferably 7% to 13%. Too high porosity may cause to deteriorate charge efficiency and discharge efficiency. Too low porosity may cause problems such that high volume capacity can hardly be obtained, and that the electrode active material layer can easily be peeled off to cause defect. Furthermore, when using a curable polymer, it is preferable to cure the polymer.

The thickness of the electrode active material layer is, for both positive electrode and negative electrode, normally 5 to 300 μm, preferably 10 to 250 μm.

(Slurry for Porous Membrane)

The slurry for a porous membrane of the present invention includes oxide particle having a particle size of 5 nm or more to 100 nm or less, polymer having a glass-transition temperature of 15° C. or less and solvent (disperse medium).

The solid content concentration of the slurry for a porous membrane is not particularly limited if the after-mentioned coating and dipping steps are applicable and its viscosity shows fluidity, and in general, the solid content concentration is 20 to 50 mass % or so.

Also, the disperse medium of the slurry for a porous membrane is not particularly limited if the medium can uniformly disperse the above solid content. In general, water, acetone, tetrahydrofuran, methylene chloride, chloroform, dimethyl formamide, N-methylpyrrolidone, cyclohexane, xylene, cyclohexanone or mixed solvent thereof can be used.

Among these, it is particularly preferable to use acetone, cyclohexanone, tetrahydrofuran, cyclohexane, xylene or N-methylpyrrolidone, or mixed solvent thereof because of high dispersibility of the oxide particle having a particle size of 5 nm or more to 100 nm or less and the optionally-added inorganic filler. Due to low volatility and excellent workability at the time of coating the slurry, cyclohexanone, xylene or N-methylpyrrolidone, or mixed solvent thereof is further particularly preferable.

Also, the slurry for a porous membrane may further include other components such as inorganic filler, dispersant and electrolyte solution additives having functions to inhibit degradation of the electrolyte solution in addition to the above oxide particle, polymer having a glass-transition temperature of 15° C. or less and solvent. These are not particularly limited unless they affect battery reaction.

As the oxide particle having a particle size of 5 nm or more to 100 nm or less, the polymer having a glass-transition temperature of 15° C. or less, the inorganic filler, the dispersant and the like, those mentioned for the porous membrane of the present invention can be used.

The method for producing the slurry for a porous membrane is not particularly limited, and the slurry can be obtained by mixing the above oxide particle having a particle size of 5 nm or more to 100 inn or less, polymer having a glass-transition temperature of 15° C. or less, optionally-added other components and solvent. It is possible to obtain the slurry for a porous membrane in which the oxide particle having a particle size of 5 nm or more to 100 nm or less and optionally-added inorganic filler are highly dispersed by using the above components despite mix method, mixing sequence and the like.

Blending machine is not particularly limited if the machine can uniformly mix the above components, and ball mill, sand mill, pigment dispersing machine, stone mill, ultrasonic dispersing machine, homogenizer, planetary mixer and the like can be used. It is particularly preferable to use high-dispersion device able to give high dispersion share, such as beads mill, roll mill and Fill-mix. The slurry viscosity in the state of the slurry for a porous membrane is preferably 50 mPa·S to 10,000 mPa·S. The viscosity is measured at 25° C. with a revolution of 60 rpm by using B-type viscometer.

As the method for producing an electrode for a lithium-ion secondary battery of the present invention, there may be mentioned 1) the method in which the slurry for a porous membrane containing the oxide particle having a particle size of 5 nm or more to 100 nm or less, polymer having a glass-transition temperature of 15° C. or less and solvent is coated on the electrode active material layer, followed by drying; 2) the method in which the electrode active material layer is dipped in the slurry for a porous membrane containing oxide particle having a particle size of 5 nm or more to 100 nm or less, polymer having a glass-transition temperature of 15° C. or less and solvent, followed by drying; and 3) the method in which the slurry for a porous membrane containing oxide particle having a particle size of 5 nm or more to 100 nm or less, polymer having a glass-transition temperature of 15° C. or less and solvent is coated on a removable film and dried to form a film, followed by transferring the obtained porous membrane on the electrode active material layer; etc. Among these, the method 1) in which the slurry for a porous membrane containing oxide particle having a particle size of 5 nm or more to 100 nm or less, polymer having a glass-transition temperature of 15° C. or less and solvent is coated on the electrode active material layer, followed by drying is most preferable because it is easier to control the thickness of the porous membrane.

In the method for producing an electrode for a lithium-ion secondary battery of the present invention, the slurry for a porous membrane containing the oxide particle having a particle size of 5 nm or more to 100 nm or less, the polymer having a glass-transition temperature of 15° C. or less and the solvent is coated on the electrode active material layer, followed by drying.

The method for coating the slurry for a porous membrane on the electrode active material layer is not particularly limited. For example, there may be mentioned doctor blade method, dip method, reverse roll method, direct roll method, gravure method, extrusion method, brush method, etc. Among these, dip method and gravure method are preferable in view of obtaining a uniform porous membrane. As the drying method, for example, there may be mentioned drying by warm air, hot air or low wet air, vacuum drying, drying method with irradiation of (far-)infrared rays, electron beam and the like. The drying temperature varies depending on the type of the used solvent. For thoroughly removing the solvent, it is preferable to dry the membrane at high temperature of 120° C. or more with an air-blower drying machine when low-volatile solvent such as NMP is used as the solvent, for example. In contrast, when using high volatile solvent, it is possible to dry the membrane at low temperature of 100° C. or less.

Then, as needed, it is possible to improve adhesion between the electrode active material layer and porous membrane by pressure treatment with mold press, roll press and the like. However, excessive pressure treatment may cause to deteriorate porosity of the porous membrane, so that pressure and pressure time needs to be properly controlled.

The thickness of the obtained porous membrane is not particularly limited and properly determined depending on the use of the membrane or applied area, but too thin membrane may cause hardly to form a uniform membrane while too thick membrane may cause to reduce the capacity per volume (weight) in a battery. Therefore, the thickness is preferably 1 to 50 μm, and furthermore, when forming it as a protective membrane on the electrode surface, the thickness is preferably 1 to 20 μm.

The porous membrane is formed on the surface of the electrode active material layer, and particularly preferably used as the protective membrane of the electrode active material layer or as a separator. The secondary battery electrode on which the porous membrane is formed is not particularly limited, and the porous membrane can be formed on any electrodes having various constitutions. Also, the porous membrane may be formed on either surface of positive electrode or negative electrode of the lithium-ion secondary battery, and may be formed on both of positive electrode and negative electrode.

(Lithium-Ion Secondary Battery)

The lithium-ion secondary battery of the present invention comprises a positive electrode, negative electrode and electrolyte solution, and at least one of the positive electrode and negative electrode is the above electrode for a lithium-ion secondary battery.

One example in which the electrode for a lithium-ion secondary battery is used for the positive electrode and negative electrode is explained here. In a specific method for producing a lithium-ion secondary battery, for example, the positive electrode in which the porous membranes are layered and the negative electrode in which the porous membranes are layered may be layered via the separator, which is then winded or bended depending on the battery shape to fit in the battery case, followed by filling the electrolyte in the battery case and sealing the case. Also, as needed, it is possible to prevent pressure increase inside the battery and overcharge-overdischarge by setting in expanded metal, overcurrent protection element such as fuse and PTC element, and lead plate, etc. The shape of the battery may include coin shape, button shape, sheet shape, cylinder shape, square shape and flattened shape.

As the electrolyte solution, an organic electrolyte solution in which a supporting electrolyte is dissolved in an organic solvent can be used. For the supporting electrolyte, a lithium salt can be used. The lithium salt is not particularly limited, and LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, (C₂F₅SO₂)NLi and the like may be mentioned. Among these, LiPF₆, LiClO₄ and CF₃SO₃Li are preferable, which are easily dissolved in the solvent and exhibit a high degree of dissociation. These may be used in combination of two or more. As a supporting electrolyte with higher degree of dissociation is used, conductivity of the lithium-ion becomes high, so that the conductivity of the lithium-ion can be controlled depending on the type of the supporting electrolyte.

The organic solvent used for the electrolyte solution is not particularly limited if it can dissolve the supporting electrolyte, and it is preferable to use carbonates such as dimethyl carbonate (DMC), ethylene carbonate (EC), diethyl carbonate (DEC), propylene carbonate (PC), butylene carbonate (BC) and methyl ethyl carbonate (MEC); esters such as γ-butyrolactone and methyl formate; ethers such as 1,2-dimethoxy ethane and tetrahydrofuran; sulfur-containing compounds such as sulfolane and dimethyl sulfoxide; etc. Also, the mixed solution of these solvents may be used. Among these, carbonates are preferable because of high permittivity and broad range of stable potential. Lower viscosity of the used solvent may cause higher conductivity of the lithium-ion, so that the conductivity of the lithium-ion can be controlled depending on the solvent type.

The concentration of the supporting electrolyte in the electrolyte solution is normally 1 to 30 mass %, preferably 5 mass % to 20 mass %. Also, the concentration is normally 0.5 to 2.5 mol/L depending on the type of the supporting electrolytes. When the concentration of the supporting electrolyte is either too low or too high, ion conductivity tends to be lowered. Lower concentration of the used electrolyte solution may cause to increase degree of swelling of the polymer particles, so that the conductivity of the lithium-ion can be controlled by the concentration of the electrolyte solution.

The lithium-ion secondary battery of the present invention may further include a separator. As the separator, publicly-known separators comprised of microporous membrane containing polyolefin resin, such as polyethylene and polypropylene, or aromatic polyamide resin, or nonwoven fabric; etc., can be used. Note that the use of the separator can be omitted because the porous membrane used in the present invention also has a function as the separator.

### EXAMPLES

Hereinafter, the present invention will be explained based on examples, but the present invention is not limited to these examples. Note that “part” and % are based on mass in the present examples unless otherwise stated.

A variety of physical properties in the following examples and comparative examples are evaluated as follows.

(Evaluation Method)

<1. Characteristics of Electrode with Porous Membrane: Dropping Powder Characteristic>

The electrode with the porous membrane was cut into 5×5 cm, placed in a 500 ml-glass bottle and shook at 200 rpm for 2 hours in a shaking apparatus.

The rate of the dropped powder “X” was calculated as follows and evaluated according to the following criteria, where the mass of the dropped powder, the mass of the electrode before shaking, the mass of the electrode before coating the porous membrane and the mass of powder dropped off the electrode uncoated with a porous membrane when shaking the same were a, b, c and d, respectively.

X=(a−d)/(b−c−a)×100(mass %)

(Evaluative Criteria)

A: less than 1%

B: 1% or more to less than 3%

C: 3% or more to less than 5%

D: 5% or more to less than 10%

E: 10% or more to less than 20%

F: 20% or more

<2. Characteristics of Electrode with Porous Membrane: Flexibility>

The electrode was cut into a rectangle with a width of 1 cm and a length of 5 cm to make a test specimen. The test specimen was placed on the desk to face down the collector side, and a stainless bar with a diameter of 1 mm was set on the longitudinal center (at the position of 4.5 cm away from the end) thereof at the collector side to lie in width direction. The test specimen was 180-degree folded around this stainless bar to face its active material layer outside. 10 test specimens were tested, and the folded portion of the active material layer of each test specimen was observed whether there was crack or peeling. The evaluation was done according to the following criteria. Less crack or peeling indicates more excellent flexibility of the electrode.

(Evaluative Criteria)

A: no crack or peeling in all of the ten specimens was found;

B: crack or peeling was found in 1 to 3 out of 10

C: crack or peeling was found in 4 to 9 out of 10

D: crack or peeling was found in all specimens.

<3. Characteristics of Electrode with Porous Membrane: Smoothness>

The electrode was cut to prepare a test specimen with 3 cm×3 cm. The test specimen was set on a laser microscope to face down the collector side. Then, the surface roughness “Ra value” at 5 arbitrary points for the porous membrane surface was measured in the range of 100 μm×100 μm by using a 50-time lens in accordance with JIS B0601: 2001 (ISO4287: 1997). 10 test specimens were subject to measurements, and smoothness was obtained by calculating an average of the measurements. The evaluation was done according to the following criteria.

A: Ra value was less than 0.5 μm

B: Ra value was 0.5 μm or more to less than 0.8 μm

C: Ra value was 0.8 μm or more to less than 1.0 μm

D: Ra value was 1.0 μm or more to less than 1.5 μm

E: Ra value was 1.5 μm or more

### Example 1

### Preparation of Polymer

300 parts of ion-exchange water, 81.5 parts of n-butyl acrylate, 15 parts of acrylic nitrile, 3.0 parts of glycidyl methacrylate and 0.5 part of 2-acrylamide 2-methylpropanesulfonic acid, as well as 0.05 part of t-dodecyl mercaptan as a molecular weight modifier and 0.3 part of potassium persulfate as a polymerize initiator, were placed in an autoclave with a stirrer, and sufficiently stirred, followed by heating at 70° C. to polymerize the same, so that an aqueous dispersion of polymer particles was obtained. The polymerization conversion ratio obtained from the solid content concentration was approximately 99%. 100 parts of this aqueous dispersion of polymer particles were added with 320 parts of N-methylpyrrolidone (hereinafter may be referred to as “NMP”), and water was evaporated under reduced pressure to obtain NMP solution of butyl acrylate-acrylic nitrile-based copolymer (hereinafter may be referred to as “polymer A”). The glass-transition temperature of the polymer A was −5° C. Also, the content of the hydrophilic functional group (sulfonic group) in the polymer A was 0.5 mass %.

<Preparation of Slurry for Porous Membrane>

Inorganic filler (alumina, with an average particle size of 300 nm and a particle size of over 200 nm), oxide particle (Aerosil MOX80 (product name)) having an average particle size of 30 nm (particle size: in the range of 10 nm to 40 nm) and the polymer A as the binder were mixed in a mixing ratio shown in Table 1 (solid content ratio), and further mixed with NMP to have the solid content concentration of 20 mass %, followed by dispersion with beads mill, so that the slurry for a porous membrane 1 was prepared.

<Production of Electrode Composition for Negative Electrode and Negative Electrode>

98 parts of graphite having a particle size of 20 μm and specific surface area of 4.2 m²/g as the negative electrode active material and 5 parts of PVDF (polyvinylidene fluoride) in terms of solid content as the binder were mixed, and further added with NMP followed by mixing by planetary mixer to prepare electrode composition for negative electrode in slurry-state. The composition for negative electrode was coated on one side of copper foil having a thickness of 0.1 mm, and dried at 110° C. for 3 hours, followed by roll press to obtain a negative electrode having a thickness of 100 μm.

<Preparation of Electrode with Porous Membrane>

The slurry for a porous membrane 1 was coated on the negative electrode to have a thickness of 3 μm such that the negative electrode active material layer was completely covered, and then dried at 110° C. for 20 minutes, so that a porous membrane was formed thereon to obtain an electrode with porous membrane (electrode for a lithium-ion secondary battery).

For the prepared electrode with porous membrane, dropping powder characteristic, flexibility and smoothness were evaluated. The results are shown in Table 1.

### Example 2

77 parts of styrene, 19 parts of 1,3-butadiene, 3 parts of methacrylic acid, 1 part of acrylic acid, 5 parts of dodecyl benzene sodium sulfonate, 150 parts of ion-exchange water and as the polymerize initiator, 1 part of potassium persulfate were placed in a 5 MPa-pressure resisting autoclave with a stirrer, and sufficiently stirred, followed by heating at 45° C. to initiate polymerization. When monomer consumption reached to 96.0%, the mixture was cooled and the reaction was terminated to obtain an aqueous dispersion of polymer particles having solid content concentration of 42%. 100 parts of the aqueous dispersion of polymer particles were added with 320 parts of N-methyl pyrrolidone (hereinafter may be referred to as “NMP”), and water was evaporated under reduced pressure to obtain NMP solution of “polymer B”. The glass-transition temperature of the polymer B was −10° C. The content of the hydrophilic functional group (carboxylic acid) in the polymer B was 4 mass %.

Except for using polymer B as the binder instead of the polymer A, and changing the solid content mass ratio of the inorganic filler (alumina), oxide particle having an average particle size of 30 nm and binder (polymer B) as shown in Table 1, a slurry for a porous membrane and electrode with porous membrane (electrode for a lithium-ion secondary battery) were prepared as in Example 1. Then, for the prepared electrode with porous membrane, dropping powder characteristic, flexibility and smoothness were evaluated. The results are shown in Table 1.

### Examples 3 & 4

Except for changing the solid content mass ratio of the inorganic filler (alumina), oxide particle having an average particle size of 30 nm and binder (polymer A) as shown in Table 1, slurries for a porous membrane and electrodes with porous membrane (electrode for a lithium-ion secondary battery) were prepared as in Example 1. Then, for the prepared electrodes with porous membrane, dropping powder characteristic, flexibility and smoothness were evaluated. The results are shown in Table 1.

### Examples 5 to 7

Except for using oxide particle (Aerosil 300 (product name)) having an average particle size of 7 nm (particle size: in the range of 5 nm or more to 15 nm or less) in Example 5, oxide particle (Aerosil OX50 (product name)) having an average particle size of 40 nm (particle size: in the range of 10 nm or more to 90 nm or less) in Example 6 and alumina particle having an average particle size of 90 nm (particle size: in the range of 80 nm or more to 100 nm or less) in Example 7, respectively, instead of the oxide particle having an average particle size of 30 nm, slurries for a porous membrane and electrodes with porous membrane (electrode for a lithium-ion secondary battery) were produced as in Example 4. Then, for the prepared electrodes with porous membrane, dropping powder characteristic, flexibility and smoothness were evaluated. The results are shown in Table 1.

### Example 8

Except for changing the solid content mass ratio of the inorganic filler (alumina), oxide particle having an average particle size of 30 nm and binder (polymer A) as shown in Table 1, a slurry for a porous membrane and electrode with porous membrane (electrode for a lithium-ion secondary battery) were prepared as in Example 1. Then, for the prepared electrode with porous membrane, dropping powder characteristic, flexibility and smoothness were evaluated. The results are shown in Table 1.

### Example 9

300 parts of ion-exchange water, 61.5 parts of n-butyl acrylate, 35 parts of acrylic nitrile, 3.0 parts of glycidyl methacrylate and 0.5 part of 2-acrylamide 2-methylpropanesulfonic acid, in addition to 0.05 part of t-dodecyl mercaptan as a molecular weight modifier and 0.3 part of potassium persulfate as a polymerize initiator, were placed in an autoclave with a stirrer, and sufficiently stirred, followed by heating at 70° C. to polymerize, so that an aqueous dispersion of polymer particles was obtained. The polymerization conversion ratio obtained from the solid content concentration was approximately 99%. 100 parts of the aqueous dispersion of polymer particles were added with 320 parts of N-methylpyrrolidone (hereinafter may be referred to as “NMP”), and water was evaporated under reduced pressure to obtain NMP solution of butyl acrylate-acrylic nitrile-based copolymer (hereinafter may be referred to as “polymer C”). The glass-transition temperature of the polymer C was 40° C. Also, the content of hydrophilic functional group (sulfonic group) in the polymer C was 0.5 mass %.

Except for using the polymer C as the binder instead of polymer A, and changing the solid content mass ratio of the inorganic filler (alumina), oxide particle having an average particle size of 30 nm and binder (polymer C) as shown in Table 1, a slurry for a porous membrane and electrode with porous membrane (electrode for a lithium-ion secondary battery) were prepared as in Example 1. Then, for the prepared electrode with porous membrane, dropping powder characteristic, flexibility and smoothness were evaluated. The results are shown in Table 1.

### Comparative Example 1

Except for not using the oxide particle having an average particle size of 30 nm, and changing the solid content mass ratio of the inorganic filler (alumina) and binder (polymer A) as shown in Table 1, a slurry for a porous membrane and electrode with porous membrane (electrode for a lithium-ion secondary battery) were prepared as in Example 1. Then, for the prepared electrode with porous membrane, dropping powder characteristic, flexibility and smoothness were evaluated. The results are shown in Table 1.

### Comparative Example 2

Except for changing the amounts of styrene and 1,3-butadiene to 87 parts and 9 parts for styrene and 1,3-butadiene, respectively, polymerization was done as in Example 2 to obtain an aqueous dispersion of polymer D having solid content of 40%. Furthermore, NMP was added followed by evaporating water as in Example 2 to obtain NMP solution of the polymer D. The glass-transition temperature of the polymer D was 60° C.

Except for using polymer D as the binder instead of the polymer A, and changing the solid content mass ratio of the inorganic filler (alumina) and binder (polymer D) as shown in Table 1, a slurry for a porous membrane and electrode with porous membrane (electrode for a lithium-ion secondary battery) were prepared as in Comparative Example 1. Then, for the prepared electrode with porous membrane, dropping powder characteristic, flexibility and smoothness were evaluated. The results are shown in Table 1.

### Comparative Example 3

Except for using alumina having an average particle size of 200 nm (particle size is over 100 nm) instead of the oxide particle having an average particle size of 30 nm, a slurry for a porous membrane and electrode with porous membrane (electrode for a lithium-ion secondary battery) were prepared as in Example 1. Then, for the prepared electrode with porous membrane, dropping powder characteristic, flexibility and smoothness were evaluated. The results are shown in Table 1.

TABLE 1

| | Oxide Particle Having Particle | | Inorganic | | | | | |
|---|---|---|---|---|---|---|---|---|
| | Size of 5 nm to 100 nm | | Filler having | Binder | | | | |
| | Average | | Particle Size | Amount | Glass-Transition | Dropping | | |
| | Particle Size | Amount | of over 100 nm | (parts by | Temperature | Powder | | |
| Table 1 | (nm) | (parts by mass) | (parts by mass) | mass) | (° C.) | Characteristic | Flexibility | Smoothness |
| Example 1 | 30 | 2 | 95 | 3 | −5 | C | A | B |
| Example 2 | 30 | 5 | 92 | 3 | −10 | A | C | A |
| Example 3 | 30 | 10 | 87 | 3 | −5 | A | A | A |
| Example 4 | 30 | 20 | 77 | 3 | −5 | A | A | B |
| Example 5 | 7 | 20 | 77 | 3 | −5 | A | A | C |
| Example 6 | 40 | 20 | 77 | 3 | −5 | B | A | B |
| Example 7 | 90 | 20 | 77 | 3 | −5 | C | A | B |
| Example 8 | 30 | 50 | 47 | 3 | −5 | A | B | C |
| Example 9 | 30 | 10 | 87 | 3 | 40 | A | C | A |
| Comp. Ex. 1 | none | none | 97 | 3 | −5 | F | A | E |
| Comp. Ex. 2 | none | none | 97 | 3 | 60 | F | D | E |
| Comp. Ex. 3 | none | none | 97 | 3 | −5 | E | A | D |

From the results in Table 1, it was found that by the porous membrane containing the oxide particle having a particle size of 5 to 100 nm, binding property at the surface layer of the porous membrane and smoothness of the porous membrane were improved while dropping powder was reduced. Among the examples, Example 3, where soft polymer having the glass-transition temperature of 15° C. or less was used as the binder and oxide particle having a particle size of in the range of 10 to 40 nm was included in 5 to 15 parts by mass, was most excellent in dropping powder characteristic, flexibility and smoothness.

On the other hand, in the comparative examples 1 to 3, dropping powder characteristic and smoothness were particularly poor because the porous membrane contains no oxide particle having a particle size of 5 to 100 nm.

1. An electrode for a lithium-ion secondary battery, wherein a porous membrane containing an oxide particle having a particle size of 5 nm or more to 100 nm or less is layered on an electrode active material layer.

2. The electrode for a lithium-ion secondary battery as set forth in claim 1, wherein said porous membrane further includes a binder.

3. The electrode for a lithium-ion secondary battery as set forth in claim 2, wherein said binder includes a polymer having a glass-transition temperature of 15° C. or less.

4. A slurry for a porous membrane comprising an oxide particle having a particle size of 5 nm or more to 100 nm or less, a polymer having a glass-transition temperature of 15° C. or less and a solvent.

5. A method for producing an electrode for a lithium-ion secondary battery comprising: coating the slurry for a porous membrane as set forth in claim 4 on an electrode active material layer; and then drying the same.

6. A lithium-ion secondary battery comprising a positive electrode, negative electrode and electrolyte solution, wherein
at least one of the positive electrode and negative electrode is the electrode as set forth in claim 1.
